(19) United States
(12) Patent Application Publication
(10) Pub. No.: US 2025/0056378 A1
(43) Pub. Date: Feb. 13, 2025

(54) VALIDITY INFORMATION HANDLING FOR CLOSED ACCESS GROUP IN A TELECOMMUNICATIONS NETWORK

(71) Applicant: Sharp Kabushiki Kaisha, Osaka (JP)

(72) Inventor: Atsushi ISHII, Vancouver, WA (US)

(21) Appl. No.: 18/446,411

(22) Filed: Aug. 8, 2023

(51) Int. Cl. H04W 48/04; H04W 36/08; H04W 48/16

(52) U.S. Cl. CPC H04W 48/04; H04W 36/08; H04W 48/16

(57) ABSTRACT

A wireless terminal communicates with a radio access network over a radio interface and comprises receiver circuitry and processor circuitry. The receiver circuitry is configured to receive an allowed Closed Access Group (CAG) identity (CAG-ID). The allowed CAG-ID is associated with validity information, the validity information further comprising a condition for the allowed CAG-ID to be valid. The receiver circuitry is also configured to receive, from a cell of the radio access network, system information comprising one or more CAG-IDs supported on the cell. The processor circuitry is configured to impose a limitation not to consider the cell as a candidate for cell selection/reselection, in a case where the allowed CAG-ID is one of the one or more CAG-IDs but is invalid based on the validity information, and to terminate the limitation upon a change of the condition. Methods of operating such wireless terminal are also provided.

### TECHNICAL FIELD

The technology relates to wireless communications, and particularly to the validity information for a closed access group in a telecommunications network, such as use of such validity information by a wireless terminal, for example.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and g-UTRAN, the New Radio (NR).

A radio access network may comprise one or more access nodes, such as base station nodes, which facilitate wireless communication or otherwise provides an interface between a wireless terminal and a telecommunications system. A non-limiting example of an access node or base station may include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 1, and is also described in 3GPP TS 38.300. The 5G NR network is comprised of NG RAN, Next Generation Radio Access Network, and 5GC, 5G Core Network. As shown, NGRAN is comprised of gNBs, e.g., 5G Base stations, and ng-eNBs, i.e., LTE base stations. An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations, i.e., gNB & ng-eNB. A gNB node provides NR user plane and control plane protocol terminations towards the UE, and is connected via the NG interface to the 5GC. The 5G NR, New Radio, gNB is connected to AMF, Access and Mobility Management Function, and UPF, User Plane Function, in the 5GC, 5G Core Network.

A non-public network (NPN), also referred to as a private network, is a network that is intended for the non-public or private use. A non-public network (NPN) can be deployed in a variety of configurations where both virtual and physical network elements can be utilized. While there are many possible configurations of NPNs, there are two major categories of NPNs: Standalone Non-Public Network, SNPN, and Public Network Integrated NPN, PNI-NPN.

A Standalone Non-Public Network, SNPN, may be deployed in isolation corresponds to the concept of private network and may involve more investment and commitment from the owner. On the other hand, a Public Network Integrated NPN, PNI-NPN, may be deployed as a private slice, e.g., a dedicated network slice by the PLMN for the sole use of the owner, or it may involve part of the networks being deployed by the PLMN and others by the owner.

In case of a Public Network Integrated NPN, a group of users that are permitted to access to one or more relevant cells in PNI-NPN may be called as Closed Access Group, CAG. Such relevant cells may be referred as CAG cells. CAG is used for the PNI-NPNs to prevent User Equipment(s), wireless terminals, e.g., UE(s), which are not allowed to access the NPN via the CAG cells.

In 3^{rd} Generation Partnership Project (3GPP), the concept of Closed Access Group (CAG) in the context of NPN relay nodes has been standardized. Recently, enhancements to the CAG to add validity information, based on time and locations, are about to be introduced, targeting Mobile Base Station Relay, MBSR, or Mobile Integrated Access and Backhaul, IAB.

What is needed are, e.g., methods, apparatus, and/or techniques which more efficiently utilize or handle Closed Access Group (CAG) validity information and thereby facilitate improved wireless terminal operation.

### SUMMARY

In one of its example aspects the technology disclosed herein pertains to a wireless terminal which communicates with a radio access network over a radio interface. In an example embodiment and mode, the wireless terminal comprises receiver circuitry and processor circuitry. The receiver circuitry is configured to receive an allowed Closed Access Group (CAG) identity (CAG-ID). The allowed CAG-ID is associated with validity information, the validity information further comprising a condition for the allowed CAG-ID to be valid. The receiver circuitry is also configured to receive, from a cell of the radio access network, system information comprising one or more CAG-IDs supported on the cell. The processor circuitry is configured to impose a limitation not to consider the cell as a candidate for cell selection/reselection, in a case where the allowed CAG-ID is one of the one or more CAG-IDs but is invalid based on the validity information, and to terminate the limitation upon a change of the condition. Methods of operating such wireless terminal are also provided.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 shows a system diagram of an example 5G network in which Closed Access Group (CAG) validity change technology disclosed herein may be employed.

FIG. 3 is a diagrammatic view showing a message flow for the core network to configure/update CAG information for the wireless terminal.

FIG. 4 is a diagrammatic view of an example structure of CAG information and associated validity information which may be included in a downlink NAS message.

FIG. 5 is a diagrammatic view of an example procedure in which a 5G system may broadcast CAG-IDs from a CAG cell.

FIG. 6 is a diagrammatic view of an example imposition of a limitation of wireless terminal access to a CAG cell according to prior art procedure.

FIG. 7 is a schematic view of a communications network including a wireless terminal which performs enhanced Closed Access Group (CAG) validity change technology according to an example embodiment and mode.

FIG. 8 is a diagrammatic view of an example, representative, non-limiting acts of step comprising an enhanced Closed Access Group (CAG) validity change procedure which is performed in the communications network of FIG. 7.

FIG. 9 is a flow chart showing example representative steps or acts performed by an example wireless terminal of FIG. 7.

FIG. 10 is a schematic view of an example implementation of the example embodiment and mode of FIG. 7 in which the network node is a core network node.

FIG. 11 is a schematic view of an example implementation of the example embodiment and mode of FIG. 7 in which the network node is a radio access network node.

FIG. 12 is a schematic view of an example implementation of the example embodiment and mode of FIG. 7 in which the network node is distributed between a core network and a radio access network.

FIG. 13 is a diagrammatic view showing example elements comprising electronic machinery which may comprise a wireless terminal, a radio access node, and a core network node according to an example embodiment and mode.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel. All or a subset of the cell may be adopted by 3GPP as licensed bands, e.g., frequency band, to be used for communication between a base station, such as a Node B, and a UE terminal. A cellular network using frequency bands can include configured cells. Configured cells can include cells of which a UE terminal is aware and in which it is allowed by a base station to transmit or receive information. Examples of cellular radio access networks include E-UTRAN or New Radio, NR, and any successors thereof, e.g., NUTRAN.

A communication network typically comprises at least one core network and one radio access network. The core network may comprise one or more core network nodes or servers. A core network, CN, may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. For example, a core network may comprise one or more management entities, which may be an Access and Mobility Management Function, AMF.

The communication network typically comprises at least one radio access network. The radio access network typically comprises one or more access nodes. The radio access network, and hence its access nodes, are connected to the core network by core network/radio access interface link(s). The core network/radio access interface link(s) may be, for example, a RAN-CN interface (e.g., N2 interface).

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology. The access node may include, for example, one or more types of relay nodes.

A wireless terminal, which also may be referred to as user equipment or UE 30. The wireless terminal communicates over a radio or wireless interface with the radio access network. Depending on system and circumstances of operation, the wireless terminal may wirelessly communicate with one or more access nodes of one or more radio access networks. As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element, RE, is the smallest time-frequency unit for downlink transmission in the subframe. That is, one symbol on one sub-carrier in the sub-frame comprises a resource element (RE) which is uniquely defined by an index pair (k, l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix.

In 5G New Radio (“NR”), a frame consists of 10 ms duration. A frame consists of 10 subframes with each having 1 ms duration similar to LTE. Each subframe consists of 2u slots. Each slot can have either 14 (normal CP) or 12 (extended CP) OFDM symbols. A Slot is typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slot helps to achieve lower latency in 5G NR architecture. Unlike slot, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

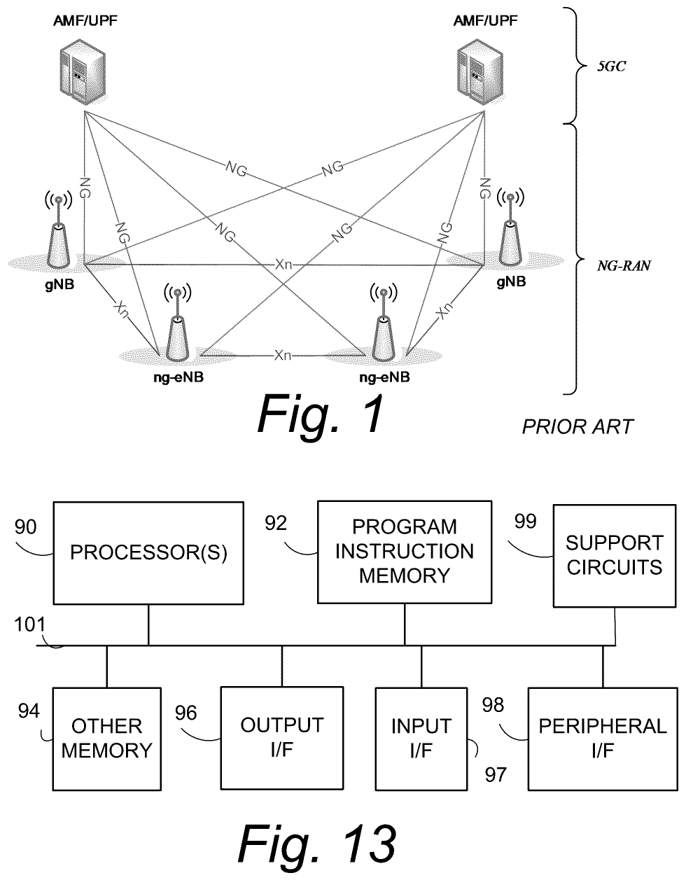

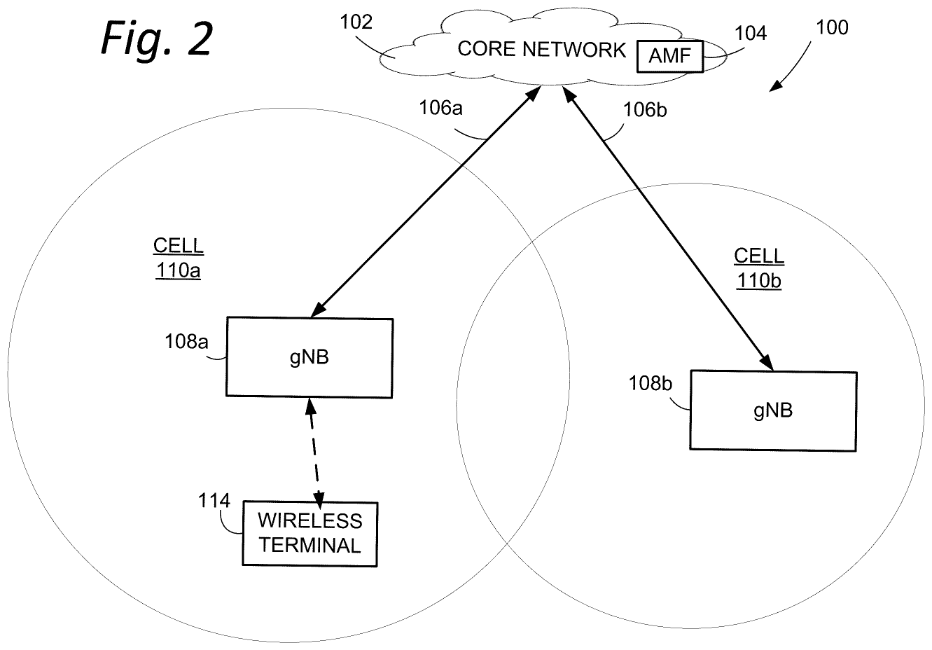

FIG. 2 shows a system diagram of an example 5G network 100 in which CAG validity change technology disclosed herein may be employed. The 5G network 100 comprises a core network 102 connected to one or more radio access network (RAN) nodes, such as gNB 108a and gNB 108b, which are connected to the core network 102 by wirelines 106a and 106b, respectively. The gNB 108a serves at least one cell 110a. Likewise, the gNB 108b service at least one cell 110b. In FIG. 1, cell 110a serves wireless terminal 114, e.g., a user equipment (UE). The core network 102 may comprise at least one Access and Mobility Management Function, AMF, 104 for handling connection and mobility management tasks. Each of cell 110a and 110b may or may not be a Closed Access Group (CAG) cell.

A Closed Access Group (CAG) may be identified by a CAG Identifier (CAG-ID), which is unique within the scope of a Public Land Mobile Network (PLMN). To use CAG, a wireless terminal, such as wireless terminal 114 of FIG. 2, that supports CAG, may be pre-configured or (re) configured with CAG information. The following is an example of types of CAG information which may be included in a subscription for the wireless terminal:
an Allowed CAG list i.e., a list of CAG-IDs the wireless terminal is allowed to access.
each entry of the Allowed CAG list may be (optionally) associated with validity information.
a CAG-only indication whether the wireless terminal is only allowed to access 5G system via CAG cells.

The above CAG information may be provided by the Home PLMN, e.g., HPLMN, on a per PLMN basis. In a PLMN the wireless terminal may only consider the CAG information provided for this PLMN. The entries of the Allowed CAG list with validity information may be provided to the wireless terminal only if the wireless terminal indicates support of CAG with validity information.

An Access and Mobility Function (AMF) of a core network, such as AMF 104 of FIG. 2, may configure/update the CAG information preferably together with the validity information specific to the wireless terminal, using one or more non-access stratum (NAS) procedures, such as a registration procedure, a configuration update procedure, and service request procedure.

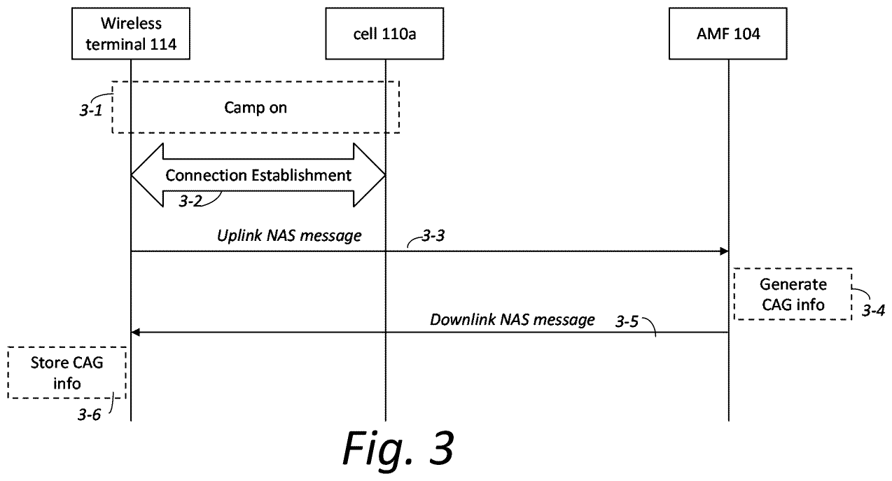

FIG. 3 shows a message flow for the core network to configure/update the CAG information for the wireless terminal, such as wireless terminal 114 of FIG. 2. Initially wireless terminal 114 may select/reselect and camp on cell 110a, as shown by Act 3-1. Then, as act 3-2, wireless terminal 114 may perform a connection establishment procedure in cell 110a, which may result in establishing a connection with gNB 108a of FIG. 2 that serves cell 110a. After the connection is successfully established, as act 3-3 wireless terminal 114 may send an uplink non-access stratum (NAS) message to AMF 104. Upon receiving the uplink NAS message, as act 3-4 AMF 104 may determine and generate CAG information for wireless terminal 114, based on subscription information for wireless terminal 114 obtained from another entity (unillustrated) in core network 102. The CAG information for wireless terminal 114 may comprise an Allowed CAG list with one or more CAG-IDs, where each of the CAG-IDs in the Allowed CAG list may optionally be associated with validity information. As act 3-5, AMF 104 may then send a downlink NAS message including the CAG information and the validity information to wireless terminal 114. As act 3-6 the downlink NAS message may be received by wireless terminal 114 and the CAG information may be stored in wireless terminal 114. In a case where the CAG information is provided during the registration procedure, for example, the uplink NAS message and the downlink NAS message may be a Registration Request message and Registration Accept message, respectively.

The validity information for CAG, possibly provided together with, or within the CAG information, may comprise one or more environmental conditions for a corresponding CAG-ID, indicating in what situation(s) the CAG ID is valid or invalid. The conditions may be a time duration(s), e.g., a CAG time duration(s); a geographic area(s), e.g., a CAG location restriction(s); altitudes; barometric pressure; or other expressions of conditions measurable for the wireless terminal. Such conditions may be configured to the wireless terminal to make sure that the wireless terminal does not access the CAG cell if some or all of the conditions are not fulfilled. For example, if the time when a certain CAG-ID is allowed for a wireless terminal expires or the wireless terminal is out of the geographic area(s), the CAG for the wireless terminal may be revoked from the network and the wireless terminal may suspend the CAG until it becomes valid again.

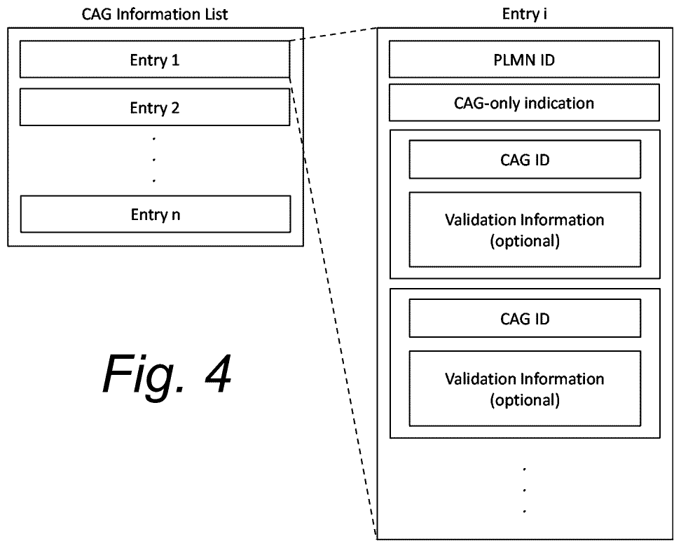

FIG. 4 illustrates an example structure of the CAG information and associated validity information, which may be included in the downlink NAS message of FIG. 3. The CAG information may comprise one or more entries, e.g., Entry 1, 2, . . . , n, each of which may comprise a PLMN ID, a CAG-only indication, e.g., as disclosed above, and one or more CAG-IDs, e.g., Allowed CAG list, associated with the PLMN ID. Some of the CAG IDs may be optionally associated with its validity information. In the case where the validity information indicates a time duration, the validity information may comprise a start time and an end time to specify the time duration. The start time or the end time may be coded with absolute time values, e.g., UTC, or relative time values, e.g., relative to the current time. In the case where the validity information indicates a geographic location restriction(s), the validity information may comprise a list of tracking area codes/identities, cell identity list, and/or any other expressions of geographic areas.

A CAG cell may broadcast information such that only wireless terminals supporting/subscribing CAG can access the cell. The CAG cell may broadcast one or multiple CAG-IDs per PLMN. The CAG cell may in addition broadcast a human-readable network name per CAG Identifier for the wireless terminals to perform manual CAG selection.

In one example implementation, the CAG cell may use one or more system information blocks (SIBs), such as SIB1 per 3GPP TS 38.331, which may comprise NPN-IdentityInfoList as shown in Listing 1.

Listing 1

| | |
|---|---|
| NPN-IdentityInfoList-r16 ::= | SEQUENCE (SIZE (1..maxNPN- |

r16)) OF NPN-IdentityInfo-r16

| | |
|---|---|
| NPN-IdentityInfo-r16 ::= | SEQUENCE { |
| npn-IdentityList-r16 | SEQUENCE (SIZE |

(1..maxNPN-r16)) OF NPN-Identity-r16,

| | |
|---|---|
| trackingAreaCode-r16 | TrackingAreaCode, |
| ranac-r16 | RAN-AreaCode |

OPTIONAL, -- Need R

| | |
|---|---|
| cellIdentity-r16 | CellIdentity, |
| cellReservedForOperatorUse-r16 | ENUMERATED {reserved, |

notReserved},

| | |
|---|---|
| iab-Support-r16 | ENUMERATED {true} |

```
OPTIONAL, -- Need S
  ...,
  [[
```

| | |
|---|---|
| qNB-ID-Length-r17 | INTEGER (22..32) |

OPTIONAL -- Need R
]]
}

| | |
|---|---|
| NPN-Identity-r16 ::= | CHOICE { |
| pni-npn-r16 | SEQUENCE { |
| plmn-Identity-r16 | PLMN-Identity, |
| cag-IdentityList-r16 | SEQUENCE (SIZE |

(1..maxNPN-r16)) OF CAG-IdentityInfo-r16
},

| | |
|---|---|
| snpn-r16 | SEQUENCE { |
| plmn-Identity-r16 | PLMN-Identity, |
| nid-List-r16 | SEQUENCE (SIZE |

(1..maxNPN-r16)) OF NID-r16
}
}

| | |
|---|---|
| CAG-IdentityInfo-r16 ::= | SEQUENCE { |
| cag-Identity-r16 | BIT STRING (SIZE (32)), |
| manualCAGselectionAllowed-r16 | ENUMERATED {true} |

OPTIONAL -- Need R
}

| | |
|---|---|
| NID-r16 ::= | BIT STRING (SIZE (44)) |

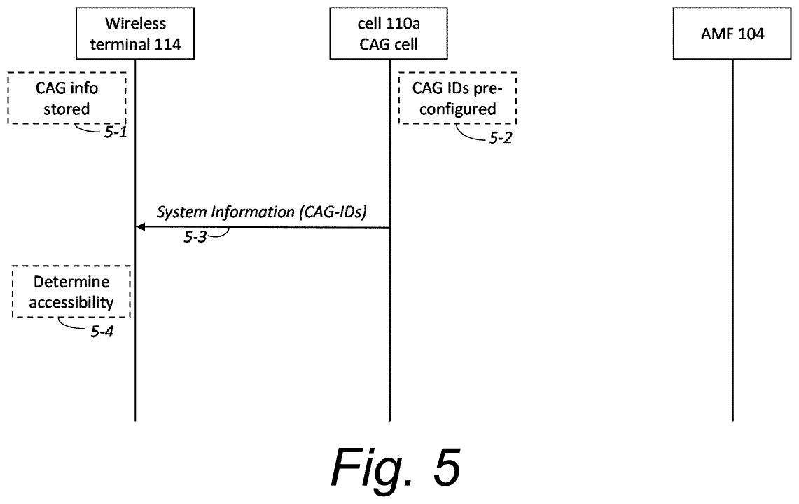

FIG. 5 shows an example procedure in which a 5G system such as the system 100 shown in FIG. 2 may broadcast CAG-IDs from cell 110a, which is assumed to be a CAG cell. Herein wireless terminal 114 may have already performed the procedure disclosed in FIG. 3 and, as shown by act 5-1, the CAG information is already stored in wireless terminal 114. Preferably independently, as shown by act 5-2, the gNB 108a which is serving the cell 110a may have been configured by AMF 104 or another entity with one or more CAG-IDs per the PLMN that the cell 110a supports. The one or more CAG-IDs may be broadcasted by cell 110a, for example by using system information. During a cell selection/reselection procedure, as act 5-3 wireless terminal 114 may attempt to select/reselect cell 110a and receive the system information broadcasted from cell 110a. The system information may comprise one or more PLMN IDs, each of which may be associated with one or more CAG-IDs. The wireless terminal may then determine whether cell 110a is accessible in context of the Allowed CAG list in the stored CAG information list as shown by act 5-4.

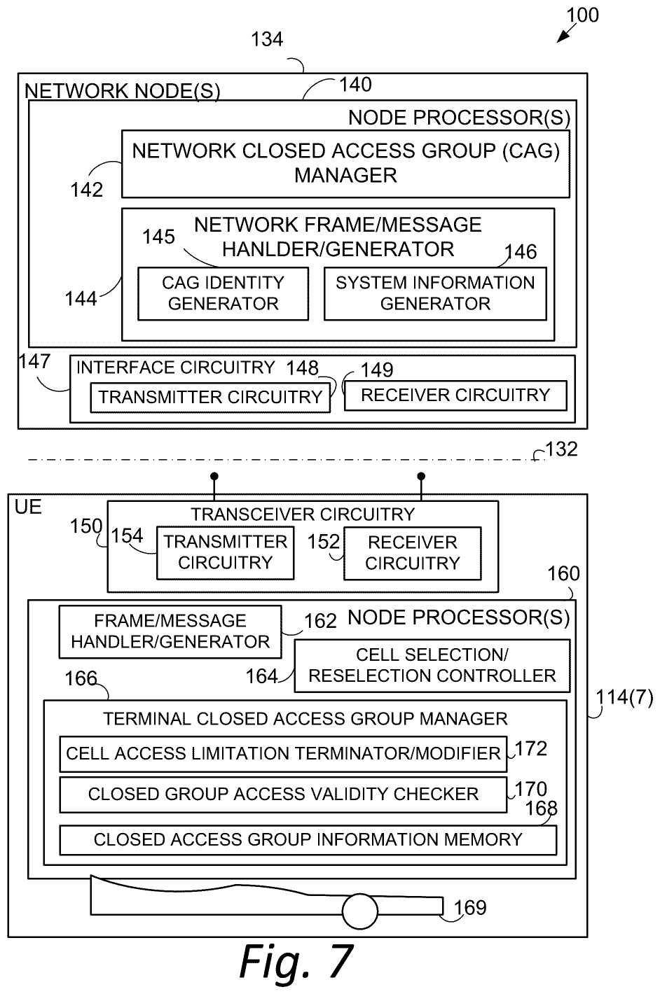

An exemplary method for wireless terminal 114 to determine the accessibility to the network is disclosed herein, particularly with reference to the example embodiment and mode of FIG. 7-FIG. 9. During a cell selection/reselection procedure, suppose that cell 110a is the highest ranking/best cell based on cell selection/reselection criteria. If cell 110a fulfills at least one of the following conditions, cell 110a may not be considered as accessible (i.e., not considered as a candidate for cell selection/reselection):
Condition 1: The cell, e.g., cell 110a, is a CAG cell which transmits/broadcasts at least one CAG-ID but no CAG ID that is present in the wireless terminal's allowed CAG list is broadcasted.
Condition 2: The cell is a CAG cell which transmits/broadcasts at least one CAG-ID and one or more CAG-IDs that are present in the wireless terminal's allowed CAG list are broadcasted, but all of the one or more CAG-IDs are invalid due to the associated validity information.
Condition 3. The cell is not a CAG cell and the CAG-only indication in the wireless terminal is set.

On the other hand, if cell 110a is the highest ranking/best cell based on cell selection/reselection criteria and fulfills none of the conditions shown above, cell 110a may be considered as accessible (i.e., considered as a candidate for cell selection/reselection), unless restricted by other reasons (e.g., cell barring).

In a case in which the wireless terminal, such as wireless terminal 114 of FIG. 2, determines that a cell, such as cell 110a, is not accessible, the wireless terminal may not consider this cell, e.g., cell 110a, and possibly other cells on the same frequency, as candidates for cell selection/reselection for a pre-determined time period, such as 300 seconds. The time period may be pre-configured at the wireless terminal or network-configured. This time period may be herein referred as a selection/reselection limitation period, or “limitation” period, and the ineligibility for the wireless terminal to access the cell may be referred to as a/the “limitation”.

In a scenario where some of the validity conditions configured to the wireless terminal changes during the selection/reselection limitation period, the wireless terminal's behavior in prior art is that the wireless terminal may continue considering the CAG cell not accessible until the end of the selection/reselection limitation period.

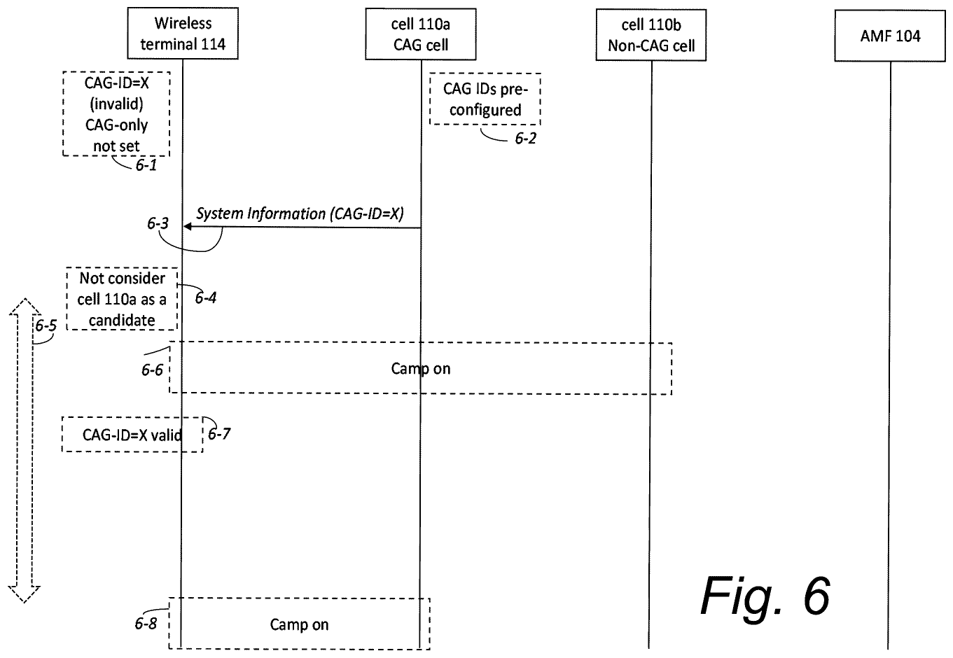

FIG. 6 shows an example scenario of such prior art behavior, and particularly a prior art implementation of limitation on a wireless terminal's access to a CAG cell. In the scenario of FIG. 6, as act 6-1 wireless terminal 114 is configured with CAG-ID=X as the Allowed CAG list and the CAG-only indication is not set. The associated validity information of CAG-ID=X may indicate that the CAG-ID is currently invalid, e.g., wireless terminal 114 may be out of the configured CAG location restriction. Act 6-2 and Act 6-3 are identical to Act 5-2 and Act 5-3 of FIG. 5, respectively. Upon receiving the system information with CAG-ID=X, as act 6-4 wireless terminal may recognize that cell 110a is not accessible, due to Condition 2 as stated above. As a result, as act 6-5 wireless terminal may start the selection/reselection limitation period for cell 110a and any other cells of the same frequency, which may cause wireless terminal 114 to trigger cell selection/reselection, which may result in camping on cell 110b as shown by act 6-6. Cell 110b is a non-CAG cell and therefore is considered to be accessible. Then, while in the wireless terminal is in a selection/reselection limitation period, as shown by act 6-7 the validity condition for CAG-ID=X changes so that CAG-ID=X now becomes valid. This change of validity condition may be due to, for example, the current time being within the CAG time duration of the CAG-ID, and/or wireless terminal 114 may be within an area of the CAG location restriction. Despite that the validity condition change, as shown in FIG. 6 the wireless terminal 114 of prior art may not terminate/end/lift the selection/reselection limitation period, which may prevent the wireless terminal from selecting/reselecting back cell 110a, or one of the other cells in the same frequency, until the limitation period expires as scheduled. After the expiration, as act 6-8 wireless terminal 114 of prior art may select/reselect and camp on cell 110a if selection/reselection criteria are fulfilled.

Thus, the scenario of FIG. 6 shows that the maintaining the selection/reselection limitation period after the validity condition change at act 6-7 blocks the wireless terminal to select/reselect the valid CAG cell. As such, since the wireless terminal is not able to select/reselect a valid CAG cell after the change of the validity information, the prior art behavior may be wasteful.

In one of its example aspects the technology disclosed herein and described particularly with reference to FIG. 7-FIG. 9, implements improved Closed Access Group (CAG) validity change technology. A wireless terminal such as a wireless terminal 114(7) of the example embodiment and mode of FIG. 7-FIG. 9 may terminate the selection/reselection limitation period for a CAG cell, and the other cells of the same frequency, upon a change of the validity information. In other words, the wireless terminal 114(7) of the example embodiment and mode of FIG. 7-FIG. 9 may not consider a cell that fulfills aforementioned Condition 2, and other cells on the same frequency, as candidates for reselection either (1) for a maximum of the pre-determined selection/reselection limitation time period, or (2) until the evaluation of the validity condition associated with the corresponding entry of the Allowed CAG list configured on the UE changes. For example, the wireless terminal 114(7) need not wait the entire previously set or default selection/reselection limitation time period before again considering the eligibility of the CAG cell, but instead may reconsider the eligibility of the CAG cell upon receipt of the changed validity information. In so doing, the wireless terminal 114(7) essentially removes or shortens the default selection/reselection limitation time period so that the wireless terminal 114(7) may earlier consider eligibility for the CAG cell.

As mentioned above, wireless terminal 114(7) of the example embodiment and mode of FIG. 7 may implement an improved Closed Access Group (CAG) validity change technology as described herein. In the example embodiment and mode of FIG. 7-FIG. 9, one or more nodes of the network may interact or communicate with the wireless terminal 114(7). Such one or more nodes may be one or more nodes of core network 102 (see FIG. 2), or one or more nodes of a radio access network, or a combination of nodes comprising the core network and the radio access network. For sake of simplicity, the one or more nodes of the network which communicate with the wireless terminal 114(7) are generically and/or collectively referred to and illustrated in FIG. 7 as network node 134. Thus, it should be understood that network node 134 may, in potentially differing example embodiments and modes, be one or more nodes of core network 102, one or more nodes of a radio access network, or may be distributed between one or more nodes of the core network and the radio access network.

As show in FIG. 7, the one or more network nodes 134 comprises network node processor(s) 140. The network node processor(s) 140 may perform many functionalities for its resident node, as understood by those skilled in the art. For performing example functions germane to the example embodiment and mode of FIG. 7, the network node processor(s) 140 may further comprise network Closed Access Group (CAG) manager 142 and network frame/message handler/generator 144. The network frame/message handler/generator 144 may comprise CAG identity message generator 145 which informs wireless terminal 114(7) of an allowed Closed Access Group (CAG) identity (CAG-ID) and validity information, the validity information further comprising a condition for the allowed CAG-ID to be valid. For example, the CAG identity message generator 145 may generate the CAG information and associated validity information which may be included in the downlink NAS message of FIG. 3 and have the example format or structure of FIG. 4. The network frame/message handler/generator 144 may further comprise system information generator 146 which broadcasts in system information one or more CAG-IDs supported on a cell for one or more of the cells served by the network node 134.

The network Closed Access Group (CAG) manager 142 administers and, when necessary, generates and changes the Closed Access Group (CAG) identities (CAG-ID) and validity information associated with network node 134. The network Closed Access Group (CAG) manager 142 is thus knowledgeable of and receptive to conditions that may affect the validity information for wireless terminals under jurisdiction of the network node 134. Further, the network Closed Access Group (CAG) manager 142 interacts with the CAG identity message generator 145 and system information generator 146 to supply information for use in the CAG identity message and the system information, respectively.

The network node 134 may further comprise network node interface circuitry 147. The network node interface circuitry 147 in turn may comprise network node transmitter circuitry 148 and network node receiver circuitry 149. The network node interface circuitry 147 may be employed for transmitting the CAG identity message generated by CAG identity message generator 145 and the system information generated/formatted by system information generator 146. The CAG identity message and the system information are ultimately transmitted to the wireless terminal 114(7) over a radio or air interface, shown as radio interface 132 in FIG. 7.

FIG. 7 further shows that the wireless terminal 114(7) may comprise wireless terminal transceiver circuitry 150. The wireless terminal transceiver circuitry 150 may in turn comprise wireless terminal receiver circuitry 152 and wireless terminal transmitter circuitry 154. The transceiver circuitry 150 may include antenna (e) for wireless transmission. The wireless terminal transmitter circuitry 154 may include, e.g., amplifier(s), modulation circuitry and other conventional transmission equipment. The wireless terminal receiver circuitry 152 may comprise, e.g., amplifiers, demodulation circuitry, and other conventional receiver equipment.

FIG. 7 further shows wireless terminal 114(7) also comprising wireless terminal processor circuitry, e.g., one or more wireless terminal processor(s) 160. The wireless terminal 114(7), e.g., wireless terminal processor(s) 160, may comprise terminal frame/message generator/handler 162. As is understood by those skilled in the art, in some telecommunications system messages, signals, and/or data are communicated over a radio or air interface using one or more “resources”, e.g., “radio resource(s)”.

The wireless terminal processor(s) 160 may perform many functionalities for its wireless terminal, as understood by those skilled in the art. For performing example functions germane to the example embodiment and mode of FIG. 7, the wireless terminal processor(s) 160 may further comprise cell selection/re-selection controller 164 and terminal Closed Access Group (CAG) manager 166. The terminal Closed Access Group (CAG) manager 166 may further comprise terminal Closed Access Group (CAG) information memory 168; Closed Access Group (CAG) validity information checker 170; and cell access limitation terminator/modifier 172. The terminal Closed Access Group (CAG) information memory 168 may include information obtained, for example, from the example, the message generated by CAG identity message generator 145, e.g., CAG information and associated validity information obtained from the downlink NAS message of FIG. 3 and may have the example format or structure of FIG. 4. Various ones of the units and functionalities mentioned may be arranged or distributed in differing manners within wireless terminal 114(7).

The wireless terminal 30 may also comprise interfaces 169, including one or more user interfaces. Such user interfaces may serve for both user input and output operations and may comprise (for example) a screen such as a touch screen that can both display information to the user and receive information entered by the user. The user interface 69 may also include other types of devices, such as a speaker, a microphone, or a haptic feedback device, for example.

The wireless terminal of the example embodiment and mode of FIG. 7-FIG. 9 thus communicates with a radio access network over a radio interface such as radio interface 132. The wireless terminal comprises receiver circuitry, such as terminal receiver circuitry 152 and processor circuitry such as wireless terminal processor(s) 160, for example. The receiver circuitry is configured to receive an allowed Closed Access Group (CAG) identity (CAG-ID). The allowed Closed Access Group (CAG) identity (CAG-ID) may be received in a CAG identity message generated by CAG identity message generator 145, for example. The allowed CAG-ID is associated with validity information, the validity information further comprising a condition for the allowed CAG-ID to be valid. The receiver circuitry is also configured to receive, from a cell of the radio access network, system information comprising one or more CAG-IDs supported on the cell. The system information may be the system information generated by system information generator 146, for example. The processor circuitry is configured to (1) impose a limitation not to consider the cell as a candidate for cell selection/reselection, in a case where the allowed CAG-ID is one of the one or more CAG-IDs but is invalid based on the validity information, and; (2) terminate the limitation upon a change of the condition. In an example embodiment and mode, the validity information may be checked by Closed Access Group (CAG) validity information checker 170 and the termination may be instigated in whole or in part by cell access limitation terminator/modifier 172.

Thus, the wireless terminal 114(7) may comprise processor circuitry 160 which is configured to detect a favorable change of the condition for the allowed CAG-ID to be valid, the favorable change of the condition is a change that causes the allowed CAG-ID to change from invalid to valid; and, in response to detection of the favorable change, to consider a cell which supports the CAG-ID as a candidate for cell selection/reselection.

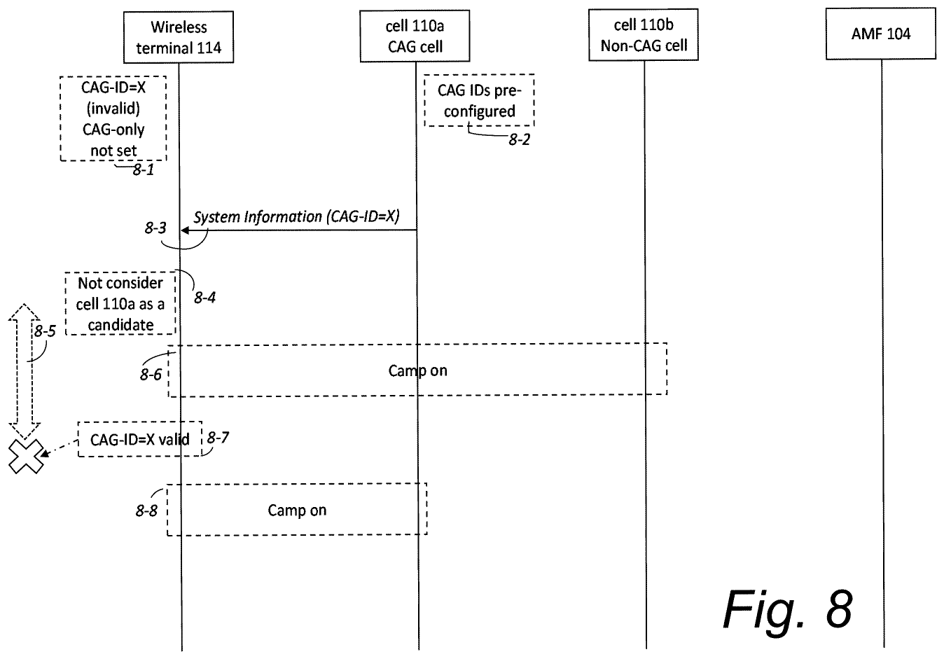

FIG. 8 shows an example scenario for the example embodiment and mode of FIG. 7-FIG. 9. Act 8-1 to Act 8-5 are identical to Act 6-1 to Act 6-5, respectively. For example, as act 8-1 wireless terminal 114(7) is configured with CAG-ID=X as the Allowed CAG list and the CAG-only indication is not set. The associated validity information of CAG-ID=X may indicate that the CAG-ID is currently invalid, e.g., wireless terminal 114(7) may be out of the configured CAG location restriction. The configuration of act 8-1 may comprise storing, e.g., the CAG ID and CAG-only indication, in terminal Closed Access Group (CAG) information memory 168. Upon receiving the system information with CAG-ID=X, as act 8-4 wireless terminal may recognize that cell 110a is not accessible, due to Condition 2 as stated above. As a result, as act 8-5 wireless terminal 114(7) may start the selection/reselection limitation period for cell 110a and any other cells of the same frequency, which may cause wireless terminal 114(7) to trigger cell selection/reselection, which may result in camping on cell 110b as shown by act 8-6. Cell 110b is a non-CAG cell and therefore is considered to be accessible. Then, while in the wireless terminal is in a selection/reselection limitation period, as shown by act 8-7 the validity condition for CAG-ID=X changes so that CAG-ID=X now becomes valid. The validity condition change may be monitored/detected by Closed Access Group (CAG) validity information checker 170.

In the FIG. 8 scenario, upon detecting the change of the validity condition for CAG-ID=X wireless terminal 114 may terminate the selection/reselection limitation period as depicted by the “X” which truncates the vertical selection/reselection limitation period arrow. The detection of the change of act 8-7 may be performed, e.g., by Closed Access Group (CAG) validity information checker 170. Terminating the selection/reselection limitation period may be initiated or implemented, in whole or in part, by cell access limitation terminator/modifier 172. Terminating the selection/reselection limitation period will allow wireless terminal 114 to consider cell 110a, and other cells on the same frequency, as a candidate(s) for cell selection/reselection. Consequently, as act 8-7 wireless terminal 114(7) can select/reselect cell 110a before the end time originally scheduled for the selection/reselection limitation period. The detection of the change of the validity condition may be based on observing environmental situations. That is, for example, if the validity condition is a time duration, wireless terminal 114(7) may be equipped with a means to keep track of current time and determine whether the current time is within the time duration. In another example, if the validity condition is a geographical location restriction, wireless terminal 114(7) may be equipped with a means to derive a current location and determine whether the current location is within the geographical location restriction.

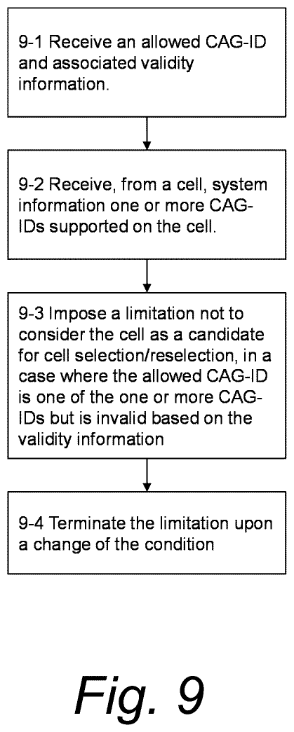

FIG. 9 is a flow chart showing example representative steps or acts performed by an example wireless terminal 114(7) of FIG. 7. Act 9-1 comprises the wireless terminal 114(7) receiving an allowed CAG identity, CAG-ID. The allowed CAG-ID may be associated with validity information, which may further comprise a condition for the allowed CAG-ID to be valid. In one example implementation, the condition may specify a time duration(s) in which the allowed CAG-ID is valid. In another example implementation, the condition may specify a geographical area(s) in which the allowed CAG-ID is valid. The allowed CAG-ID and the validity information may be configured by a core network. Act 9-2 comprises receiving, from a cell, system information comprising one or more CAG-IDs supported on the cell. Act 9-3 comprises imposing a limitation not to consider the cell as a candidate for cell selection/reselection, in a case where the allowed CAG-ID is one of the one or more CAG-IDs but is invalid based on the validity information. Act 9-4 comprises terminating the limitation upon a change of the condition. The change of the condition may be a change that causes the allowed CAG-ID from invalid to valid.

Thus, as explained herein, the technology disclosed herein involves apparatus and methods for handling validity information associated with a Closed Access Group (CAG). Specifically, a wireless terminal may lift/stop restrictions/limitations for selection/reselection on a CAG cell upon a change of the validity information.

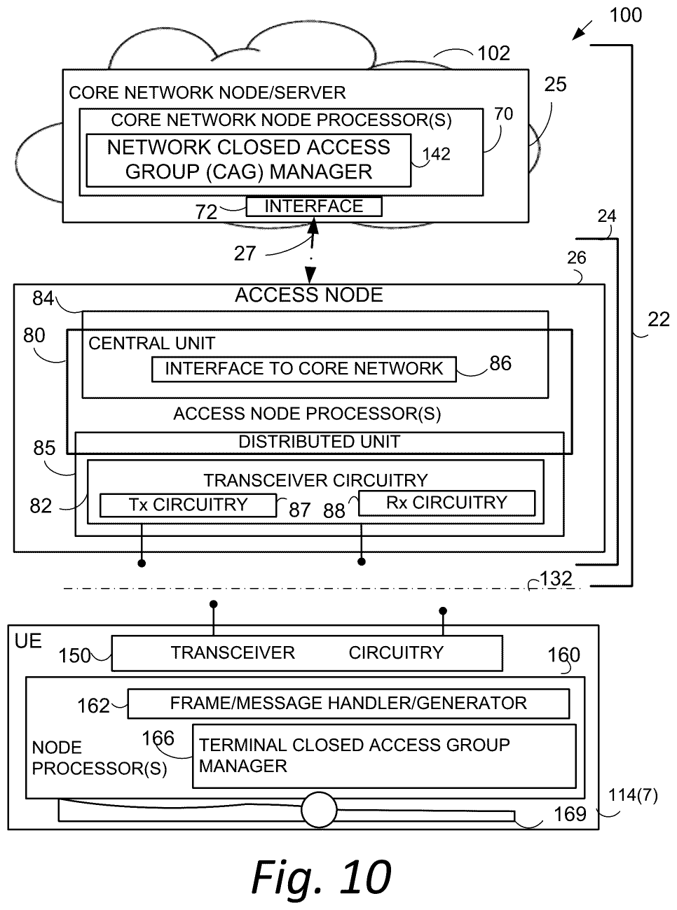

It was mentioned above that network node 134 may, in potentially differing example embodiments and modes, be one or more nodes of core network 102, one or more nodes of a radio access network, or may be distributed between one or more nodes of core network 102 and a radio access network. FIG. 10-FIG. 12 shows example embodiments and modes of communication network 100 in which core network 102 comprises core network node 25 and in which radio access network 24 comprises access node 26. The core network node 25 in turn comprises core network node processor(s) 70 and core network node interface(s) circuitry 72.

The access node 26 of FIG. 10-FIG. 12 may comprise access node processor(s) 80 and access node transceiver circuitry 82. The access node 26 may comprise distributed architecture and may also comprise access node central unit 84 and access node distributed unit 85. The access node central unit 84 may comprise access node interface circuitry 86 to the core network 23. The access node distributed unit 85 may comprise access node transceiver circuitry 82. The access node transceiver circuitry 82 may include access node transmitter circuitry 87 and access node receiver circuitry 88.

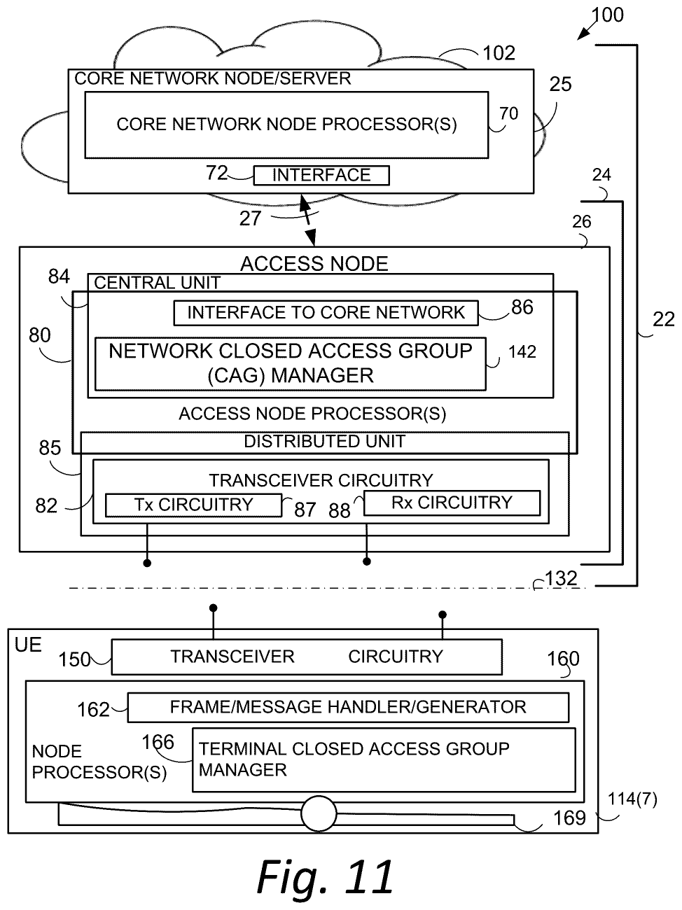

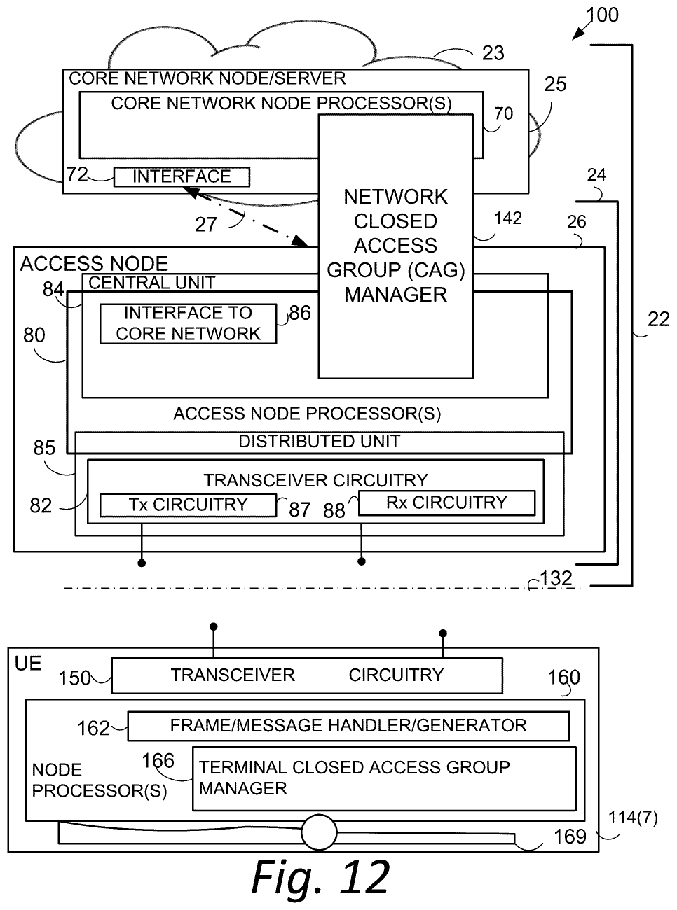

In the example embodiment and mode of FIG. 10 the network node 134 comprises the core network node 25 since network Closed Access Group (CAG) manager 142 resides in the core network node 25. By contrast, in the example embodiment and mode of FIG. 11 the network node 134 comprises the access node 26 since the network Closed Access Group (CAG) manager 142 resides in the access node 26 of FIG. 11. By further contrast, in the example embodiment and mode of FIG. 12 the network node 134 comprises both the core network node 25 and the access node 26 since the network Closed Access Group (CAG) manager 142 resides at least partially in both the core network node 25 and in the access node 26 of FIG. 12, e.g., is distributed among one or more nodes of the core network 23 and radio access network 24.

Certain units and functionalities of the systems 100 may be implemented by electronic machinery. For example, electronic machinery may refer to the processor circuitry described herein, such as terminal processor circuitry 160, core network node processor(s), and access node processor(s). Moreover, the term “processor circuitry” is not limited to mean one processor, but may include plural processors, with the plural processors operating at one or more sites. Moreover, as used herein the term “server” is not confined to one server unit but may encompass plural servers and/or other electronic equipment and may be co-located at one site or distributed to different sites. With these understandings, FIG. 13 shows an example of electronic machinery, e.g., processor circuitry, as comprising one or more processors 90, program instruction memory 92; other memory 94 (e.g., RAM, cache, etc.); input/output interfaces 96 and 97, peripheral interfaces 98; support circuits 99; and busses 101 for communication between the aforementioned units. The processor(s) 90 may comprise the processor circuitries described herein, for example, wireless terminal processor(s) 160, core network node processor(s), access node processor(s), or any processor(s) of a network entity of the core network.

A memory or register described herein may be depicted by memory 94, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 99 are coupled to the processors 90 for supporting the processor in a conventional manner. These circuits include cache, power supplies, clock circuits, input/output circuitry and subsystems, and the like.

The term “configured” may relate to the capacity of a device whether the device is in an operational or non-operational state. Configured may also refer to specific settings in a device that affect the operational characteristics of the device whether the device is in an operational or nonoperational state. In other words, the hardware, software, firmware, registers, memory values, and/or the like may be “configured” within a device, whether the device is in an operational or nonoperational state, to provide the device with specific characteristics.

An interface may be a hardware interface, a firmware Interface, a software interface, and/or a combination thereof. The hardware interface may include connectors, wires, electronic devices such as drivers, amplifiers, and/or the like. A software interface may include code stored in a memory device to implement protocol(s), protocol layers, communication drivers, device drivers, combinations thereof, and/or the like. A firmware interface may include a combination of embedded hardware and code stored in and/or in communication with a memory device to implement connections, electronic device operations, protocol(s), protocol layers, communication drivers, device drivers, hardware operations, combinations thereof, and/or the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided using hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The technology of the example embodiments and modes described herein encompasses a non-transitory computer readable medium encoded with a computer program that, when executed by a computer or processor of the wireless terminal described herein, causes the computer to implement the acts described herein, and/or a non-transitory computer readable medium encoded with a computer program that, when executed by a computer or processor of the mobile base station relay described herein, causes the computer to implement the acts described herein.

Moreover, each functional block or various features of the wireless terminals and nodes employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves operation of wireless terminals with Closed Access Group (CAG) capability.

Example embodiment and modes of the technology disclosed herein include but are not limited to the following:

Example Embodiment 1: A wireless terminal which communicates with a radio access network over a radio interface, the wireless terminal comprising:
receiver circuitry configured to:
   receive an allowed Closed Access Group (CAG) identity (CAG-ID), the allowed CAG-ID being associated with validity information, the validity information further comprising a condition for the allowed CAG-ID to be valid, and;
   receive, from a cell of the radio access network, system information comprising one or more CAG-IDs supported on the cell;
processor circuitry configured to:
   impose a limitation not to consider the cell as a candidate for cell selection/reselection, in a case where the allowed CAG-ID is one of the one or more CAG-IDs but is invalid based on the validity information, and;
   terminate the limitation upon a change of the condition.

Example Embodiment 2: The wireless terminal of Example Embodiment 1, wherein the change of the condition is a change that causes the allowed CAG-ID to change from invalid to valid.

Example Embodiment 3: The wireless terminal of Example Embodiment 1, wherein the condition specifies a time duration(s) in which the allowed CAG-ID is valid.

Example Embodiment 4: The wireless terminal of Example Embodiment 1, wherein the condition specifies a geographical area(s) in which the allowed CAG-ID is valid.

Example Embodiment 5: The wireless terminal of Example Embodiment 1, wherein the allowed CAG-ID and the validity information is configured by a core network.

Example Embodiment 6: The wireless terminal of Example Embodiment 1, wherein the processor circuitry is further configured to consider the cell as the candidate cell for cell selection/reselection upon termination of the limitation.

Example Embodiment 7: A method in a wireless terminal comprising:
receiving an allowed Closed Access Group (CAG) identity (CAG-ID), the allowed CAG-ID being associated with validity information, the validity information further comprising a condition for the allowed CAG-ID to be valid, and;
receiving, from a cell, system information comprising one or more CAG-IDs supported on the cell;
imposing a limitation not to consider the cell as a candidate for cell selection/reselection, in a case where the allowed CAG-ID is one of the one or more CAG-IDs but is invalid based on the validity information, and;
terminating the limitation upon a change of the condition.

Example Embodiment 8: The method of Example Embodiment 7, wherein the change of the condition is a change that causes the allowed CAG-ID to change from invalid to valid.

Example Embodiment 9: The method of Example Embodiment 7, wherein the condition specifies a time duration(s) in which the allowed CAG-ID is valid.

Example Embodiment 10: The method of Example Embodiment 7, wherein the condition specifies a geographical area(s) in which the allowed CAG-ID is valid.

Example Embodiment 11: The method of Example Embodiment 7, wherein the allowed CAG-ID and the validity information is configured by a core network.

Example Embodiment 12: The method of Example Embodiment 7, further comprising considering the cell as the candidate cell for cell selection/reselection upon termination of the limitation.

Example Embodiment 13: A wireless terminal which communicates with a radio access network over a radio interface, the wireless terminal comprising:
receiver circuitry configured to receive, from the radio access network, an allowed Closed Access Group (CAG) identity (CAG-ID), the allowed CAG-ID being associated with validity information, the validity information further comprising a condition for the allowed CAG-ID to be valid, and;
processor circuitry configured:
   to detect a favorable change of the condition for the allowed CAG-ID to be valid, the favorable change of the condition is a change that causes the allowed CAG-ID to change from invalid to valid; and,
   in response to detection of the favorable change, to consider a cell which supports the CAG-ID as a candidate for cell selection/reselection.

Example Embodiment 14: The wireless terminal of Example Embodiment 13, wherein the condition specifies at least one of the following:
a time duration(s) in which the allowed CAG-ID is valid; and
a geographical area(s) in which the allowed CAG-ID is valid.

Example Embodiment 15: The wireless terminal of Example Embodiment 14, wherein the favorable change of the condition is a change that causes the allowed CAG-ID to change from invalid to valid.

Example Embodiment 16: The wireless terminal of Example Embodiment 14, wherein the favorable condition specifies a time duration(s) in which the allowed CAG-ID is valid.

Example Embodiment 17: The wireless terminal of Example Embodiment 14, wherein the favorable condition specifies a geographical area(s) in which the allowed CAG-ID is valid.

Example Embodiment 18: The wireless terminal of Example Embodiment 14, wherein the allowed CAG-ID and the validity information is configured by a core network.

One or more of the following documents may be pertinent to the technology disclosed herein (all of which are incorporated herein by reference in their entirety):
3GPP TS 38.304 V17.5.0 (2023-06), 3rd Generation Partnership, Technical Specification Group Radio Access Network; NR; User Equipment (UE) procedures in Idle mode and RRC Inactive state (Release 17)
3GPP TS 38.331 V17.5.0 (2023-06), 3rd Generation Partnership Project; Technical Specification Group Radio Access Network; NR; Radio Resource Control (RRC) protocol specification (Release 17)

Although the description above contains many specificities, these should not be construed as limiting the scope of the technology disclosed herein but as merely providing illustrations of some of the presently preferred embodiments of the technology disclosed herein. Thus, the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A wireless terminal which communicates with a radio access network over a radio interface, the wireless terminal comprising:
receiver circuitry configured to:
receive an allowed Closed Access Group (CAG) identity (CAG-ID), the allowed CAG-ID being associated with validity information, the validity information further comprising a condition for the allowed CAG-ID to be valid, and;
receive, from a cell of the radio access network, system information comprising one or more CAG-IDs supported on the cell;
processor circuitry configured to:
impose a limitation not to consider the cell as a candidate for cell selection/reselection, in a case where the allowed CAG-ID is one of the one or more CAG-IDs but is invalid based on the validity information, and;
terminate the limitation upon a change of the condition.

2. The wireless terminal of claim 1, wherein the change of the condition is a change that causes the allowed CAG-ID to change from invalid to valid.

3. The wireless terminal of claim 1, wherein the condition specifies a time duration(s) in which the allowed CAG-ID is valid.

4. The wireless terminal of claim 1, wherein the condition specifies a geographical area(s) in which the allowed CAG-ID is valid.

5. The wireless terminal of claim 1, wherein the allowed CAG-ID and the validity information is configured by a core network.

6. The wireless terminal of claim 1, wherein the processor circuitry is further configured to consider the cell as the candidate cell for cell selection/reselection upon termination of the limitation.

7. A method in a wireless terminal comprising:
receiving an allowed Closed Access Group (CAG) identity (CAG-ID), the allowed CAG-ID being associated with validity information, the validity information further comprising a condition for the allowed CAG-ID to be valid, and;
receiving, from a cell, system information comprising one or more CAG-IDs supported on the cell;
imposing a limitation not to consider the cell as a candidate for cell selection/reselection, in a case where the allowed CAG-ID is one of the one or more CAG-IDs but is invalid based on the validity information, and;
terminating the limitation upon a change of the condition.

8. A wireless terminal which communicates with a radio access network over a radio interface, the wireless terminal comprising:
receiver circuitry configured to receive, from the radio access network, an allowed Closed Access Group (CAG) identity (CAG-ID), the allowed CAG-ID being associated with validity information, the validity information further comprising a condition for the allowed CAG-ID to be valid, and;
processor circuitry configured:
to detect a favorable change of the condition for the allowed CAG-ID to be valid, the favorable change of the condition is a change that causes the allowed CAG-ID to change from invalid to valid; and,
in response to detection of the favorable change, to consider a cell which supports the CAG-ID as a candidate for cell selection/reselection.

9. The wireless terminal of claim 8, wherein the condition specifies at least one of the following:
a time duration(s) in which the allowed CAG-ID is valid; and
a geographical area(s) in which the allowed CAG-ID is valid.

10. The wireless terminal of claim 8, wherein the favorable change of the condition is a change that causes the allowed CAG-ID to change from invalid to valid.

11. The wireless terminal of claim 8, wherein the favorable condition specifics a time duration(s) in which the allowed CAG-ID is valid.

12. The wireless terminal of claim 8, wherein the favorable condition specifies a geographical area(s) in which the allowed CAG-ID is valid.

13. The wireless terminal of claim 8, wherein the allowed CAG-ID and the validity information is configured by a core network.
